(19) United States
(12) Patent Application Publication
(10) Pub. No.: US 2010/0162301 A1
(43) Pub. Date: Jun. 24, 2010

(54) TARGETED ADVERTISING MANAGEMENT

(75) Inventor: Dan Minnick, Littleton, CO (US)

Correspondence Address: DORSEY & WHITNEY LLP;on behalf of EchoStar Technologies, L.L.C., 370 Seventeenth St., Suite 4700, Denver, CO, 80202-5647, US

(73) Assignee: EchoStar Technologies L.L.C., Englewood, CO (US)

(21) Appl. No.: 12/344,056

(22) Filed: Dec. 24, 2008

(51) Int. Cl. H04N 7/025; H04N 5/445

(52) U.S. Cl. 725/34; 725/38; 705/14.49

(57) ABSTRACT

The present invention is directed to a system and method for managing the display of a targeted advertisement. In one embodiment an advancing functionality is inhibited or modified in connection with the display of a stored video or other stored content. In inhibiting or modifying an advancing function a user is forced or otherwise encouraged to watch a directed advertisement. The present invention may include status or indicator information which enables the particular functionality in connection with the targeted advertisement.

### TECHNICAL FIELD

The technical field of embodiments discussed herein generally relates to systems and methods for managing directed advertisements.

### BACKGROUND

Broadcast receivers may include or may be associated with storage devices which are operable to store video content. The video content may be, for example, a previously or currently aired broadcast and/or a pay-per-view feature. Storing a video locally at a receiver enables a user to view the stored content at a time which is convenient for the user. In this regard, a user may have the option of forwarding or advancing the display of stored content using, for example, a fast-forward operation. While this functionality provides an added convenience for a user, an advertising provider suffers due to the fact that a user will typically forward or advance through commercials or advertisements. This is particularly problematic for providers of targeted advertisements. Targeted advertisements are directed to a particular person or group of people and may be expensive to produce. Accordingly, resources are wasted if a targeted viewer forwards through or skip these type of targeted advertisements.

Accordingly, it may be desirable to enforce or otherwise encourage viewing of a targeted advertisement. In particular, it may be desirable to have a system and method for managing viewing options in connection with display of stored video content that includes a targeted advertisement or is associated with a targeted advertisement.

### SUMMARY

Embodiments discussed herein are directed to a system and method for managing the display of a targeted advertisement. In one embodiment, an advancing functionality is inhibited or modified in connection with the display of a stored video or other stored content.

One embodiment is directed to a method managing content in a receiver, including: displaying video content, wherein, the video content is stored locally at a user device; receiving an indication that a targeted advertisement associated with the video content is showing; and in response to receiving the indication of a targeted advertisement is showing, taking at least one predetermined action.

Another embodiment is directed to a method of managing content in a broadcast service, including: associating an indicator with a targeted advertisement; and transmitting the targeted advertisement and the indicator; wherein the indicator specifies at least one predetermined action to be taken by a receiver when the receiver displays stored content associated with the targeted advertisement.

Another embodiment is directed to a receiver including: a tuner operable to receive a signal; a decoder connected to the tuner and configured to decode the signal into a decoded signal; the decoded signal including video content associated with at least one targeted advertisement; a storage device connected to the decoder and configured to store the video content as stored content; and a processor connected to the storage device and configured to take at least one predetermined action in connection with the targeted advertisement

### BRIEF DESCRIPTION OF THE DRAWINGS

FIG. 1 is a schematic illustration of an operating environment showing components and features of embodiments discussed herein;

FIG. 2 is a flowchart illustrating a method for managing content in a receiver in accordance with embodiments discussed herein;

FIG. 3 is a flowchart illustrating further aspects of the method illustrated in FIG. 2;

FIG. 4 is a flowchart illustrating further aspects of the method illustrated in FIG. 2; and

FIG. 5 is a flowchart illustrating another method in accordance with embodiments discussed herein.

### DETAILED DESCRIPTION OF EMBODIMENTS

Embodiments discussed herein are directed to a system and method for managing a targeted advertisement (ad), including preventing a user from advancing through a targeted advertisement. The targeted advertisement may be associated with buffered or stored video content. For example, the targeted advertisement may be included in a broadcast that is recorded and stored on a user-operated device. Such user-operated recording devices may include, without limitation, digital video recorders (DVR), receivers that are operable to store purchased content such as pay-per-view features, and so on. As used herein, a receiver may be any device capable of receiving a broadcast or other delivery of video content, such as for example, a set-top, a cable box, general purpose computer, and so on. A DVR may be integrated in a receiver, or it may be a stand alone device. Typically, DVRs are operated by a user who programs the device to record a particular program at a specified time. When the broadcast occurs, the DVR device will record and store the broadcast, which can then be viewed by a user at a convenient time. In addition to this functionality, DVRs may buffer a certain amount of content during a live video broadcast. Buffering a live video broadcast allows a user to pause and/or rewind the broadcast and to then display the broadcast in a non-live or delayed manner. In recording or buffering a video broadcast, a DVR or other recording device will record featured content such as movies or TV shows as well as advertisements that may include targeted ads.

In addition to recorded and/or buffered broadcast content the targeted ad may also be associated with a pay-per-view item. As can be appreciated by one of ordinary skill in the art, a pay-per-view item may include video content such as movies or sporting items that are delivered to a receiver or set top box for a fee. A pay-per-view fee may entitle a user to view the feature for a set period, during which the pay-per-view feature may be stored locally at the user's receiver or device.

Embodiments discussed herein operate in the context of a play-back or other non-live display of stored video content. In this context, a user may advance the recording or stored content. As used herein, “advance” or “advancing” refers to an action taken by a user to avoid a certain portion or portions of the stored content. This may include a “fast-forward” operation or function that displays the stored content at a faster than normal rate. Alternatively, “advancing” may include a “skip-ahead” operation or function that entirely avoids a certain portion of the stored content and jumps to a certain place in the stored content. As can be appreciated, a user will typically advance through or past portions of the stored content which he or she does not wish to view. In advancing past these portions of a stored video, a user may more quickly arrive at a portion of the stored video that he or she wishes to view. More specifically, a user may advance past commercials or advertisements in a stored video, and play a show, feature or other user-desired content at normal speed. This ability of a user to advance or forward past an advertisement presents a problem for targeted advertising providers. While fast forwarding is an advantage to the user who can selectively view desired content, it may be a drawback to an advertising provider whose advertisements go unviewed.

Embodiments discussed herein are directed to managing a targeted ad in the context of playback or other non-live display of a stored video or recording. As used herein, a “non-live display” may include a live broadcast that is recorded by a receiver. This may includes recordings that are captured from a live broadcast and stored in a long-term storage device. Alternatively, a “non-live display” may include replaying portions of a live broadcast that are continually captured by a buffer or other memory device as the broadcast occurs. A “non-live display” may additionally include video content delivered to the receiver such as an on-demand video or pay-per-view item. As used herein, a “targeted advertisement” or “targeted ad” refers to an advertisement that is designed and/or delivered with the intention of being viewed by a specific person or group of people. A targeted advertisement may be designed and/or delivered based on information that is collected or otherwise known about a particular person or group of people. The information may include, for example, ages or age groups, locations and so on. Additionally, information about a person or group of people associated with a particular account, receiver or location may be inferred from their purchases or other choices made through a broadcast service. For example, inferences may be made about a person's likes or dislikes based on the type of movies and/or television shows that they choose to view or purchase. Through a person's subscription to a broadcast service, information may be gathered about a person's age, gender and/or other specific likes and dislikes. Through information so gathered, a targeted ad may be delivered and/or shown to a person and/or group of people based on an expectation of the type of product or service that he or she may wish to purchase. Generally, the targeted ad may be inserted at a particular time during a broadcast by a device that is associated with the targeted user or group of users. Specifically, the targeted ad may be delivered and stored at a particular device such as a receiver or a cable head end. A broadcast may include a marker or other indicator designating a particular position of the broadcast for insertion of a targeted ad. Additionally, the marker or other indicator may specify that a targeted advertisement to be inserted be of a particular length. At this point, if one is available, a targeted advertisement may be inserted into the broadcast at the designated time.

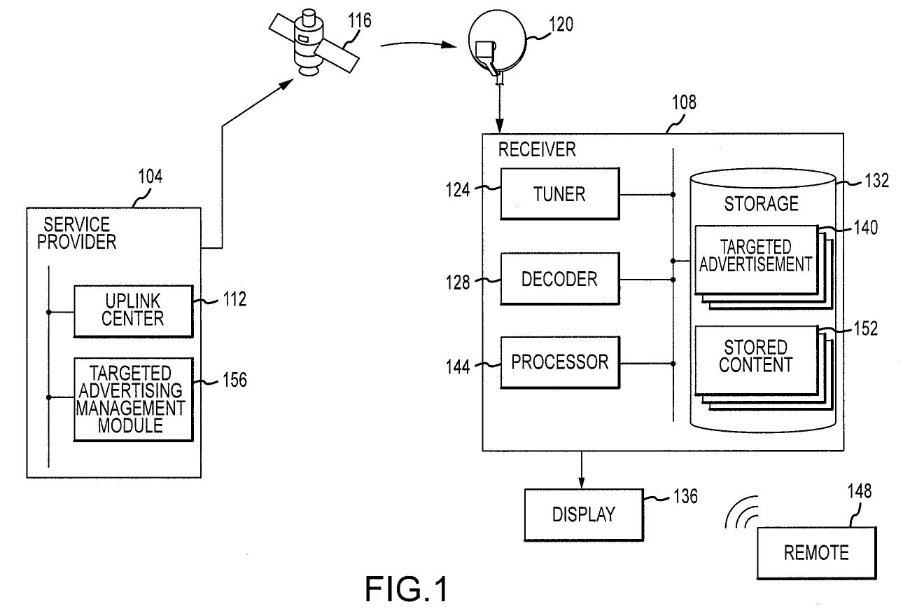

FIG. 1 is a schematic illustration of a general operating environment showing components and features of embodiments discussed herein. FIG. 1 includes a service provider 104 that transmits or otherwise provides a broadcast to a receiver 108. As used herein, a service provider 104 may include any broadcast service such as, without limitation, a satellite broadcast, a direct television broadcast or a cable television broadcast. The receiver 108 may be associated with an individual, business or other entity that receives a broadcast from the service provider 104. The broadcast may be received through a subscription to the service. It should be understood that the term “broadcast” generally embraces not only satellite or terrestrial broadcasts but also transmission of information across any wired or wireless transmission medium. Accordingly, a broadcast encompasses transmission of information across a cable network for example a cable head end to a cable receiver, an Internet or other computer accessible medium including a local area network, wide area network and so on, a wireless network such as a radio frequency or infrared network and so on.

Embodiments discussed herein may operate with a satellite broadcast service. In that regard, the service provider 104 may include an uplink center 112. The uplink center 112 may include a transmitter or other equipment operable to transmit a modulated signal having data representing audio and/or visual content. The modulated signal is received at a satellite 116, which in turn rebroadcasts the modulated signal to be received at one or more terrestrial locations. The rebroadcast signal is received from a satellite at one or more satellite dishes 120, which are typically associated with a particular receiver 108.

The receiver 108 may include a tuner 124 operable to receive the broadcast signal through the satellite dish 120 and a decoder 128 to decode the received broadcast signal. The decoder 128 may be programmed to decrypt or otherwise decode some or all of the satellite broadcast in accordance with purchases and selections made by a user. A memory or other storage device 132, such as magnetic or optical storage, may additionally be provided to store data received from the decoded satellite signal. The storage device 132 may be volatile or non-volatile memory implemented using any known technique or technology such as, for example, random access memory (RAM), disk storage, flash memory, solid state and so on. The storage device 132 may be located within the receiver 108 or separately from the receiver 108. The stored data set may include audio and/or visual content to be transmitted and displayed through display 136.

As mentioned above, a targeted advertisement may be transmitted and locally stored. In this regard, the embodiment shown in FIG. 1 may include one or more targeted advertisements 140 stored in storage 132. The targeted advertisement 140 may be sent to the receiver 108 from the service provider 104 via the satellite 116 at an appropriate time. In particular, the targeted advertisement 140 may be sent prior to or concurrently with a satellite broadcast. The targeted advertisement 140 may be inserted into a particular broadcast by the receiver 108 when a pre-defined marker or other indicator is encountered during a particular broadcast. Typically, the marker indicates a portion of the broadcast in which the targeted advertisement 140 may be inserted. The pre-determined broadcast period may include a default advertisement or other content that is displayed in the event that no targeted advertisement 140 is available for insertion in the broadcast. It should be appreciated that a broadcast may include several advertisements, any number of which may be targeted advertisements or replaced advertisements. For example, a particular commercial break or segment may include four commercials or advertisements, one of which is a targeted advertisement.

Delivery of targeted advertisements is described above in connection with embodiments that include a satellite broadcast. Satellite broadcasts such as these permit a content or advertisement provider to receive and store targeted advertisements or other supplemental content at a local receiver. Further, it should be appreciated that many methods or types of broadcast delivery do not require a service provider to deliver targeted advertisements directly to a particular receiver or household. For example, in connection with a cable television service a targeted advertisement may be delivered to a cable head end. The targeted advertisement may then be inserted into a particular broadcast at the cable head end and delivered to a plurality of receivers. In such an environment, the targeted advertisements may be designed and/or delivered with less specificity than in a satellite implementation. In particular, as the targeted advertisement must be directed to a larger group of people less specificity is available to the designer of the targeted advertisement.

Stilling referring to FIG. 1, the receiver 108 may additionally include a processor 144 operable to run executable code in connection with various functions associated with the receiver 108. In particular, the processor 144 may perform such tasks as executing commands received from a user. User commands may be sent to the receiver 108 through a user input device such as remote 148 or other wireless device (it should be appreciated that other input devices such as a computer mouse or touch screen may be used). Such commands sent to the receiver 108 may include for example a command to change the broadcast channel, a command to pause and/or rewind a live broadcast, a command to record a particular broadcast and/or a command to purchase a pay-per-view item. Commands sent to the receiver 108 may be entered through a dedicated display menu. As a result of one or more of these commands, a video or other broadcast may be stored locally at storage 132 as stored content 152. The stored content 152 may include for example recorded broadcasts, pay-per-view items and/or buffered portions of a live video broadcast.

The processor 144 may additionally be operable to receive a command from the remote 148 directed to replaying and/or broadcasting the stored content 152 on the display 136. Through operations of the processor 144, a receiver 108 in accordance with embodiments discussed herein may be operable to manage the display of stored content 152. In displaying the stored content 152, a user may typically have access to a fast-forwarding or other advancing function that is operable to advance the display of the stored content 152 past such portions as advertisements that the user does not wish to view. Embodiments discussed herein are directed to a system and method that inhibits or modifies a user's ability to access this type of functionality. The user may be inhibited or prevented from fast-forwarding or otherwise advancing a display of stored content 152 that includes or is otherwise associated with a targeted advertisement. In one embodiment, the stored content 152 may be a recorded broadcast that includes a targeted advertisement. More particularly, the targeted advertisement 140 may have been inserted into the stored content 152 at the time that the stored content 152 was originally broadcast. Alternatively, the targeted advertisement 140 may be locally stored at the receiver 108 and may be viewed at normal speeds in exchange for enablement of some particular feature associated with the stored content 152. In the case that the stored content 152 is a pay-per-view item the enabled feature may include an extended time period for which the pay-per-view feature or item is allowed to remain in storage 132.

While embodiments are discussed herein in connection with the exemplary satellite broadcast system shown in FIG. 1, it should be appreciated that embodiments discussed herein may be used in connection other types of networks or content delivery mechanisms. Generally, embodiments discussed herein include content delivered from a provider to a receiver across or over a network. The network across which content may be delivered may include satellite system, such as the one shown in FIG. 1. Alternatively, the network may include a cable television network, local area network, wide area network or the Internet. In connection with certain embodiments, a receiver may include a general purpose computer operable to receive data or other content across a network, such as a wide area network of the internet. In such embodiments, the computer may be configured so that a provider can a web site, a file transfer protocol (FTP) site, a file sharing system or site, and so on.

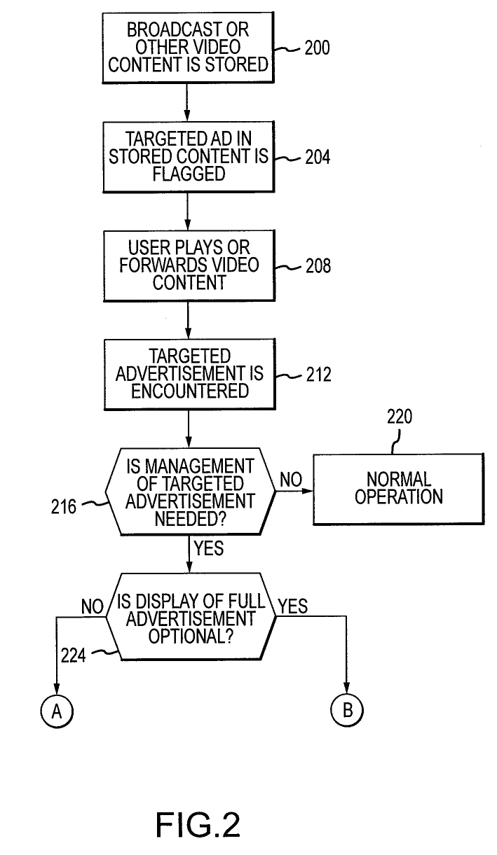

Turning now to the operation of the receiver 108 in connection with the display of stored content 152, reference is made to FIG. 2. FIG. 2 includes a flowchart illustrating operations in accordance with a method discussed herein. Initially, at operation 200, a broadcast or other video content is stored in the storage 132. As described above, the stored content 152 may be, for example, a recorded broadcast, a buffered portion of a live broadcast and/or a pay-per-view item or feature.

At operation 204, a portion of the stored content 152 may be tagged or otherwise flagged as having or otherwise being associated with a display of a targeted advertisement. In one embodiment, this may include distinguishing a targeted ad from other non-targeted ads within the stored content 152. The tag may indicate that a targeted ad is displayed during the play-back or other display of the stored content 152. The tag or other indicator may be associated with the stored content 152 at the time the stored content 152 is placed in storage 132. Alternatively, the tag indicating a targeted advertisement may be inserted prior to storage such as at the service provider 104.

At operation 208, the stored content 152 is displayed on the display 136 by the receiver 108. The receiver 108 may display the stored content 152 in response to a command issued by a user through the remote 148 other input device. For example, a user may play back a recorded video or play a pay-per-view movie or other feature. As part of operation 208, the user may play the stored content 152 at a normal speed or may play the stored content 152 at a fast or accelerated speed.

At operation 212, a portion of the stored content 152 is encountered or reached that includes a targeted advertisement or indication of a targeted advertisement. This may include the flag or other indicator inserted into the stored content 152. As described above, the flag may be inserted when the stored content is written to the storage 132 or concurrently with the broadcast from the service provider 104. It should be appreciated that an indication that a target advertisement is to be displayed may be encountered at the beginning of the stored content 152. This may occur, for instance, in connection with the display of a pay-per-view item. In particular, a targeted ad may be viewed initially in exchange for enhanced features associated with the pay-per-view feature.

At operation 216, the receiver 108 determines if management of the targeted advertisement is needed. Typically, the need for management of the targeted advertisement may be indicated by a flag or status indicator associated with the stored content 152. This may include a tag or other indicator inserted initially into the stored content 152. In accordance with embodiments discussed herein a flag or status indicator may be modified at some point during the time period in which the stored content 152 is stored in storage 132. In this regard, management of a targeted advertisement may be needed only during an initial or some number of initial displays of the stored content 152. More particularly, after a predetermined number of displays of the stored content 152 a status or other indicator may be written to the stored content 152 indicating that management of the targeted advertisement is no longer needed. In this way a user may be forced to watch a targeted advertisement only for a set number of times after which the stored content may be available with full functionality of a fast-forward or other advancing function enabled. As part of operation 216, if it is determined by the receiver 108 that management of the targeted advertisement is not needed, operation 220 may follow wherein the receiver 108 functions under normal operating conditions. Alternatively, if at operation 216, management of the targeted advertisement is needed, operation 224 will be executed.

At operation 224, receiver 108 determines if the user has the option of watching the targeted advertisement or bypassing it. In one embodiment, the user will be forced to watch the targeted advertisement at normal speed. Typically, in connection with recorded broadcasts and/or buffered live broadcasts that include a targeted advertisement viewing of the targeted and may not be optional. In accordance with embodiments discussed herein, the user is given the option of watching a targeted advertisement. In exchange for watching a targeted advertisement, one or more features may be enabled. In connection with a pay-per-view feature one or more features may be enabled exchange for a user viewing a targeted advertisement. As described above, this may include extending the period of time in which the pay-per-view feature is stored available for viewing.

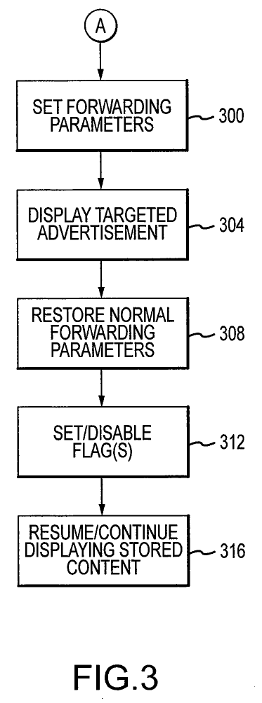

If, at operation 224, the receiver 108 determines that viewing the targeted advertisement is not optional, operation 300, shown in FIG. 3, will be executed. Turning now to FIG. 3, initially at operation 300 the receiver, through for example an operation of the processor 144 sets operating parameters or modifies the operation of the remote 148 or other user input device. In particular, a fast-forwarding or other advancing function is modified or disabled for a duration of the targeted advertisement. In one embodiment, the advancing feature is completely disabled such that the entire targeted advertisement is displayed at normal speed. Alternatively, in connection with receivers that are operable to forward video content at a variety of speeds, a first portion of the forwarding speeds may be disabled while a second portion of the forwarding speeds may be enabled. In particular, the user may be allowed to view the targeted advertisement at normal speed or at twice speed and be prohibited from viewing the targeted advertisement at four times normal speed, eight times normal speed and sixteen times normal speed. Alternatively, the forwarding function may be modified and/or prohibited only during a portion of the targeted advertisement. In particular, the receiver 108 may force an initial portion of the targeted advertisement to be displayed at normal speed and thereafter allow a user to forward or advance through the remainder of the targeted advertisement.

At operation 304, the targeted advertisement is displayed. As part of operation 304, the forwarding parameters 308 that were set in operation 300 are in effect. Accordingly, the receiver 108 forces the targeted advertisement or a portion thereof to be displayed at a particular speed.

At operation 308, all or a portion of the targeted advertisement has been displayed by the receiver 108. More particularly, that portion of the target ad that the receiver forces to be displayed at normal speed has been displayed. Following this, the normal operation or functionality of the user input device may be restored by the receiver 108. In particular, as part of operation 308, the user is given access to the full functionality which is typically associated with playing and/or forwarding stored content 152.

At operation 312, one or more flags or other indicators may optionally be set or disabled by the receiver 108. As part of operation 312, the receiver 108 may control the manner in which the targeted advertisement is displayed in connection with subsequent viewings. As described above, embodiments discussed herein may stipulate that a targeted advertisement must be viewed only a particular number of times, after which forwarding may be enabled. Accordingly, operation 312 may include setting or clearing a flag or incrementing a counter associated with the stored content 152. When the stored content 152 is again played or otherwise displayed on display 136 the receiver 108 will recognize that management of the targeted advertisement is no longer needed (described above in connection with operation 216). Following operation 312, normal operation of the receiver 108 may resume at operation 316.

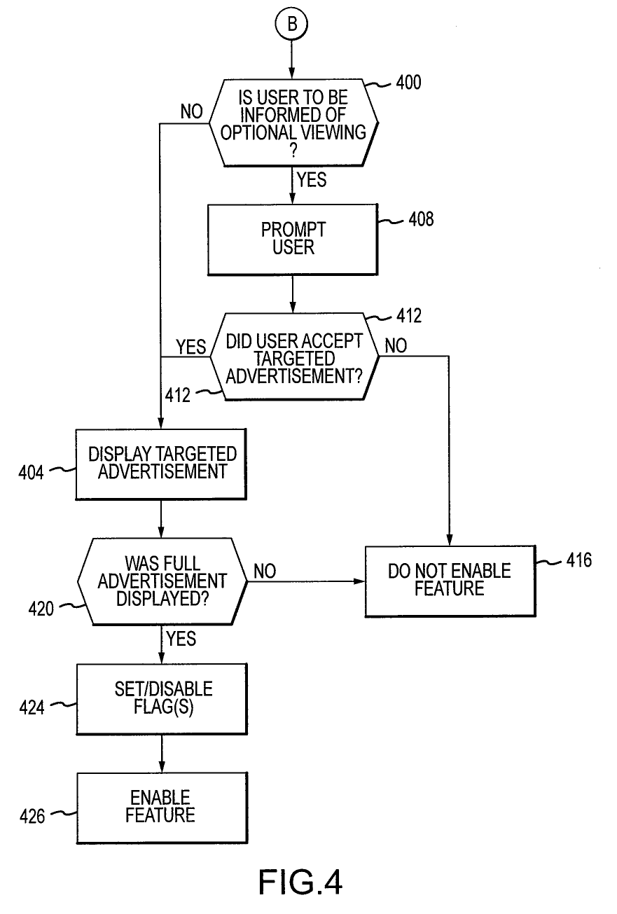

FIG. 4 is a flow chart illustrating a method in accordance with embodiments discussed herein. The flow chart of FIG. 4 begins initially with operation 400. Operation 400 follows operation 215 (shown in FIG. 2) when it is determined that display of the full targeted advertisement is optional. At operation 400, the receiver determines if the user is to be informed of the option of viewing a targeted advertisement. If the user need not be informed of option of watching the targeted advertisement, the embodiment proceeds to operation 404 directly wherein the targeted advertisement is displayed.

Alternatively, the user may be informed of the optional viewing of a targeted advertisement in operation 408. In operation 408, a prompt or other user message is displayed on the display 136. Such user prompts may include a statement indicating that the user will receive or be given access to one or more enhanced features in exchange for his or her watching of a targeted advertisement. The user may then select to view the targeted advertisement through an operation of the remote 148 or other input device.

At operation 412, the receiver 108 determines if the user has accepted the offer to watch a targeted advertisement. If at operation 412, the user in fact did accept the offer to watch the targeted advertisement the targeted advertisement may be displayed as part of the operation 404. Alternatively, if the user did not accept the offer, operation 416 may be executed. At operation 416, the receiver 108 functions normally without the enhanced feature being enabled or provided.

At operation 404, the targeted advertisement is displayed. As part of operation 404, the targeted advertisement may be displayed on the display 136 with or without disabling or otherwise modifying the fast forward or other advancing function. In certain embodiments the fast forward or other advancing function remains enabled. In this embodiment, the user voluntarily watches the targeted advertisement for its entire duration or a portion thereof and, in exchange, gains access to the enhanced feature. In accordance with embodiments discussed herein, the receiver 108 forces the entire targeted ad to be displayed by methods described above including disabling or otherwise modifying the fast forward or other advancing function of the remote 148 or other user input device.

At operation 420, the receiver 108 determines if the full advertisement was displayed. This optional step may be used in connection with embodiments that do not include disabling the fast forward or other advancing function. In this case, if the user has in fact accepted the offer to view the targeted advertisement and then fast-forwards or otherwise advances through the targeted advertisement, he or she will not have access to the enabled feature. More particularly, the embodiment will proceed to execute operation 416 where the receiver 108 functions without the enabled feature.

If, at operation 420, the receiver 108 determines that the targeted advertisement was displayed as required to enable the enhancement feature, the embodiment will execute operation 424. At operation 424, one or more flags or status indicator bits may be set or disabled. This may include providing an indication that the targeted advertisement has been viewed. Accordingly, subsequent viewings of the stored content 152 will not require or lead to a forced display of the targeted advertisement.

At operation 426, a special feature or enhanced or function is enabled in connection with the stored content 152. This enabled feature is provided in exchange for the user's viewing of a targeted advertisement. As described above, this may include extending the time period for which the stored content 152 is available for viewing.

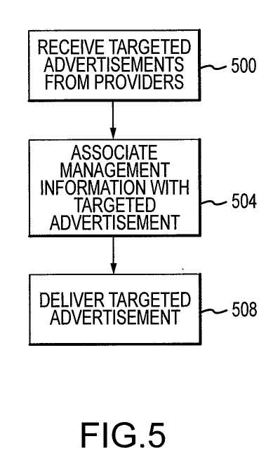

Turning now to an operation of the service provider 104 in accordance with embodiments discussed herein, reference is made to FIG. 5. FIG. 5 is a flowchart showing operations of a targeted advertising management module 156, which may be associated with the service provider 104. The targeted advertising management module 156 may be located in the uplink center 112 or located remotely therefrom. Initially, at operation 500 the targeted advertising management module compiles and/or receives one or more targeted advertisements from providers. As can be appreciated by one of skill in the art, such providers may include providers of goods and/or services whose products are advertised through advertisements shown in connection with a satellite broadcast or other broadcast.

At operation 504, the targeted advertising management module 156 may associate management information with one or more of the targeted advertisements. Management information may include one or more status bits or blocks of information that indicate the manner in which the targeted advertisement is to be presented when the ad is displayed as part of a play-back or other non-live display of stored content. As described above, this can include an indication of the number of times that the targeted advertisement must be displayed at normal speed, whether or not viewing of the targeted advertisement is optional, one or more features that may be enabled in exchange for a viewing of the targeted advertisement, and so on.

In accordance with embodiments discussed herein the particular targeted advertisement may include an expiration date. More particularly the expiration date provides a time limit or date past which the targeted advertisement will no longer be run. The expiration date may be needed to prevent old or out of date information from being displayed to a user. Accordingly, in operation 504, the targeted advertising management module may associate one or more expiration dates with a particular targeted advertisement.

At operation 508, the targeted advertisement is delivered. In accordance with embodiments that are implemented in a satellite broadcast, this delivery of the targeted advertisement may include sending one or more targeted advertisements to the receiver 108 through the satellite 116 and satellite dish 120. In accordance with embodiments discussed herein delivering a targeted advertisement may include transmitting the targeted advertisement to a cable head end through an appropriate network connection. At the cable head end, the targeted advertisement may be inserted in a broadcast as needed. Alternatively, the targeted ads may be stored for use in connection with a individual's request for display of a pay-per-view item. In the event that the target advertisement becomes part of a live broadcast that is recorded by a user or is associated with a pay-per-view item, the information that is stored therein may be used to manage the display of the targeted ad.

The foregoing merely illustrates certain principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

1. A method managing content in a receiver, comprising:
displaying video content, wherein the video content is stored locally at a user device;
receiving an indication that a targeted advertisement associated with the video content is showing; and
in response to receiving the indication of a targeted advertisement is showing, taking at least one predetermined action;
wherein the predetermined action includes disabling an advancing function during at least a portion of a display of the targeted advertisement.

2. (canceled)

3. The method of claim 1, wherein the predetermined action includes prompting a user to choose to watch the targeted advertisement and if the user does choose to watch the targeted advertisement, a feature is enabled.

4. (canceled)

5. (canceled)

6. The method of claim 35, wherein the feature includes an extension of time in which the video content is permitted to remain stored on the user device.

7. The method of claim 1, wherein:
the predetermined action includes displaying the targeted advertisement; and
in response to the user allowing the entire targeted advertisement to be displayed without advancing, a time in which the video content is stored at the user device is extended

8. The method of claim 1, wherein the predetermined action includes allowing normal operation of an advancing function if the targeted advertisement has been previously displayed.

9. The method of claim 1, wherein the video content includes a recording of a live broadcast including the targeted advertisement, the targeted advertisement having been inserted in the broadcast when the broadcast occurred

10. A method of managing content in a broadcast service, comprising:
associating an indicator with a targeted advertisement; and
transmitting the targeted advertisement and the indicator;
wherein the indicator specifies at least one predetermined action to be taken by a receiver when the receiver displays stored content associated with the targeted advertisement, the predetermined action including disabling an advancing function during a display of the targeted advertisement.

11. The method of claim 10, wherein:
the stored content includes a recording of a broadcast including the targeted advertisement, the targeted advertisement having been inserted in the broadcast when the broadcast occurred.

12. The method of claim 10, wherein the predetermined action includes enabling a feature if the targeted advertisement is displayed without advancing.

13. (canceled)

14. The method of claim 12, wherein the feature includes extending the time in which video content is allowed to be stored at the receiver.

15. (canceled)

16. The method of claim 10, wherein the targeted advertisement is transmitted to a cable head end.

17. A receiver, comprising:
a tuner operable to receive a signal;
a decoder connected to the tuner and configured to decode the signal into a decoded signal, the decoded signal including video content associated with at least one targeted advertisement;
a storage device connected to the decoder and configured to store the video content as stored content; and
a processor connected to the storage device and configured to take at least one predetermined action in connection with the targeted advertisement;
wherein the predetermined action includes disabling an advancing function during at least a portion of a display of the targeted advertisement.

18. The receiver of claim 17, wherein:
the stored content includes a recording of a live video broadcast including the targeted advertisement, the targeted advertisement having been inserted when the broadcast occurred.

19. The receiver of claim 16 wherein the predetermined action includes enabling a feature if the targeted advertisement is displayed without advancing.

20. The receiver of claim 19, wherein the feature includes extending the time in which video content is allowed to be stored at the receiver.

21. The method of claim 1, wherein the video content includes a tag distinguishing the targeted advertisement from non-targeted advertisements associated with the video content.

22. The method of claim 22, wherein the tag is inserted by the receiver when the video content is stored at the receiver.

23. The system of claim 17, wherein the processor is further operable to a set a flag after the stored content is played indicating that the stored content as been played.

24. The system of claim 17, wherein the processor is further operable to disable the advancing function during an initial portion of the display of the stored content and enable the advancing function during a remainder of the display of the stored content.

25. The system of claim 17, wherein the advancing function is a fast forward function having a plurality of speeds and the processor is further operable to disable the fast forward function for a first portion of the plurality of speeds and enable the fast forward function for a second portion of the plurality of speeds.
